(19) United States
(12) Patent Application Publication
(10) Pub. No.: US 2006/0052129 A1
(43) Pub. Date: Mar. 9, 2006

(54) Method and device for playing MPEG Layer-3 files stored in a mobile phone

(75) Inventors: Yi Hong, Taipei (TW); Li Yu, Taipei (TW); Tony Tsai, Taipei (TW); David Ho, (US)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: Inventec Applicance Corp.

(21) Appl. No.: 11/151,019

(22) Filed: Jun. 13, 2005

(30) Foreign Application Priority Data
Sep. 3, 2004 (TW) 093126611

(51) Int. Cl. H04M 1/00

(52) U.S. Cl. 455/550.1; 455/556.1

(57) ABSTRACT

A method and device for playing MPEG Layer-3 (MP3) files stored in a mobile phone is disclosed, which enables users to stereophonically enjoy the MP3 music stored in the mobile phone with expending battery power economically or even expending no additional battery power. The device can connect the mobile phone to speakers to enable the MP3 files stored in the mobile phone to be played openly so that the user can enjoy music without wearing earphones. The device also provides an electrical charger for the mobile phone and the audio amplifier to play MP3 music files stored in the mobile phone with a sound quality comparing that of high-end audio equipment and an economical expense of battery power; the device can apply to all the mobile phones with MP3 playing function.

### BACKGROUND OF THE PRESENT INVENTION

### RELATED DOCUMENTS

The present application claims priority to the following foreign application: Taiwan Patent Application Serial No.: 093126611 filed on Sep. 3, 2004, which application is incorporated herein by reference in its entirety.

1. Field of the Invention

The present invention relates to a method and device for a mobile phone with MPEG Layer-3 (MP3) playing function. More particularly, this invention can play MP3 music files stored in the mobile phone with a sound quality reaching to high-end audio equipment and save the battery energy.

2. Description of the Related Art

MP3 denotes an algorithm for digital music compression MPEG Layer-3. A sound is destructively compressed into a MP3 file by MPEG technology, which only takes one-tenth memory space compared to a WAV file (CD standard) at a same interval of time. However, as the human ears can hardly identify the potions lost in the destructive compression, the sound of MP3 music is similar to that of CD. In addition, MP3 player has no motor and related mechanical elements, MP3 player is free from the problems induced by vibration or impact. Also, the sound of MP3 music files has the quality close to that of CDs. Further, the MP3 file is small, so it is easy to distribute in networks. Accordingly, MP3 has become the most popular music format in the Internet age.

Being the most popular hand-carried electronic product, the mobile phone has evolved from the original voice communication tool into a portable electronic device integrating functions of voice communication, information, network, personal digital assistant (PDA), image, and entertainment. Thus, the appearance and popularity of the MP3 mobile phone is a corollary.

The MP3 mobile phone can take the place of MP3 player for satisfying the demand of enjoying MP3 music anytime and anywhere; however, the sound quality from an earphones can not compare with the sound quality from a high-end audio apparatus. It is obviously that simply enjoying MP3 music with earphones cannot satisfy the people demand of enjoying high-quality stereophonic music. Although there are some MP3 mobile phones can be connected to speakers to play MP3 music, the sound quality thereof lacks stereophonic effect and is almost similar to that of a general recorder/player device when earphones are plugged out. Also, the volume of music is also lower. Further, when a MP3 mobile phone plays MP3 music files continuously, the consumption of battery power is appreciable. Users often find when their MP3 mobile phones are connected to speakers to play MP3 music, the battery is soon used up after only few songs played, which reveals the drawback of high power consumption in that case and brings some inconvenience to the users.

### SUMMARY OF THE INVENTION

The objects of this invention are to improve high power consumption of battery and insufficient stereophonic effect of the sound played from earphones.

The acoustic field is the key factor of high fidelity and stereophonic effect. The acoustic field is an invisible three-dimensional space configured by sound and is defined by the relative positions of the microphones and the sound sources. An appropriate acoustic field is an enough space for music instruments to present the detail of music so that the sound of various music instruments wouldn't be blurred. When speakers play music, the acoustic field depends upon the playing space and the quality of audio equipment. Suitable playing space and excellent audio equipment are the key point for the acoustic field.

The depth represented by speakers is the sensation of the distance between the wall reflecting music sound and the microphone receiving the reflected music sound when the speakers replay music. Depth is the basis of music instrument positioning and music sound gradation.

When music is played from a general recorder/player device or earphones, the three-dimensional space of in-situ performance and the relative positions of the microphones and the sound sources cannot be configured so the music lacks stereophonic effect.

To achieve a real surround stereophonic effect, there should be at least four simulating channels, including a left channel, a right channel, a central channel, and a band-limited low-frequency rear surround channel. The so-called 5.1 channel, including a left channel, a right channel, a central channel, a left surround channel, a right surround channel and a band-limited low-frequency rear surround channel, has a much better audio effect than that of quadraphonic audio equipment.

The method of the present invention of solving the stereophonic problem is to reprocess the analog or digital signal output from the mobile phone's MP3 file so that the MP3 file can be played on multiple speakers, which are disposed in different positions of a space, in order to simulate the stereophonic conditions of in-situ music performance, wherein the audience can perceive different music volume sent out by each music instrument, each music instrument's position from which the music sound of individual music instrument emanates, and gradation of echo. The method of the this invention can otherwise process the signal from music source with a delay in order to simulate the lag effect resulting from echo reflected from the wall of in-situ performance space for creating a virtual stereophonic and surround effect.

The method of the present invention of solving the problem of battery's rapid exhaustion when a MP3 mobile phone plays MP3 files is to provide a power supply module in order to transform the alternating-current power into a direct-current power to provide abundant and endless energy for the mobile phone so that battery exhaustion will not be a problem, and further, the power supply module can also provide appropriate powers for other circuit modules in the present invention.

Further, to enable the present invention to be more conveniently used, the present invention provides an automatic-interruption design which enables to interrupt MP3 file playing once the mobile phone receives an incoming call and enable the user to undertake a conversation without holding the mobile phone.

### BRIEF DESCRIPTION OF THE DRAWINGS

The embodiments of the method and device for playing MP3 files stored in a mobile phone of the present invention will be described in detail in cooperation with the attached drawings, wherein:

FIG. 1 shows schematically the diagram of the device for playing MP3 files stored in a mobile phone according to one embodiment of the present invention;

FIG. 2 shows the process flowchart of the method for playing MP3 files stored in a mobile phone according one embodiment of the present invention;

FIG. 3 showing schematically the diagram of the device for playing MP3 files stored in a mobile phone according to another embodiment of the present invention;

FIG. 4 shows schematically the process flowchart of the method for playing MP3 files stored in a mobile phone according to another embodiment of the present invention;

FIG. 5 shows schematically the diagram of the device for playing MP3 files stored in a mobile phone according to yet another embodiment of the present invention;

FIG. 6 shows the process flowchart of the method for playing MP3 files stored in a mobile phone according to yet another embodiment of the present invention;

FIG. 7 shows schematically the diagram of the device for playing MP3 files stored in a mobile phone according to still another embodiment of the present invention;

FIG. 8 shows the process flowchart of the method for playing MP3 files stored in a mobile phone according to still another embodiment of the present invention;

FIG. 9 shows schematically the diagram of the device for playing MP3 files stored in a mobile phone according to further another embodiment of the present invention; and

FIG. 10 shows the process flowchart of the method for playing MP3 files stored in a mobile phone according to further another embodiment of the present invention.

### DETAILED DESCRIPTION OF THE INVENTION

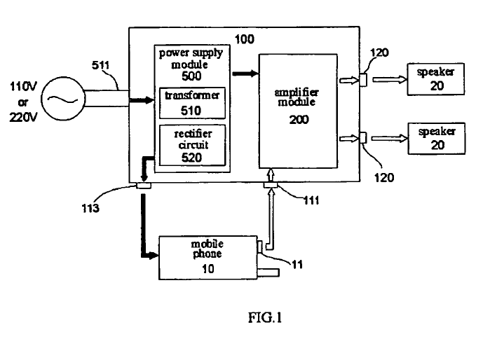

Referring to FIG. 1, the schematic diagram of the device for playing MP3 files stored in a mobile phone according to one embodiment of the present invention is shown. The device 100 for playing MP3 files stored in a mobile phone comprises at least one amplifier module 200, which is coupled to an analog signal connector 111 in the device 100 to receive, process, and amplify analog signals from an earphone socket 11 of a mobile phone 10. The processed and amplified signals are sent to a speaker-connector assembly 120, via which the device 10 can be connected to speakers 20 to output audio signal.

Also referring to FIG. 1, the device 100 for playing MP3 files stored in a mobile phone also comprises a power supply module 500, which is coupled to an external alternating-current power source and provides power for the aforementioned amplifier module 200 and other circuits. The device 100 also comprises a power output connector 113. The direct-current power transformed from the alternating-current power can be provided to the mobile phone 10 via the power output connector 113. The aforementioned power supply module 500 further comprises a transformer 510 and a rectifier circuit 520. The voltage of alternating-current power coupled to the primary side of the power supply module 500 can be 110 or 220 V according to different alternating-current standards in various areas, and the power supply module 500 can provide different voltage levels of direct-current power to various mobile phones fabricated by different manufacturer.

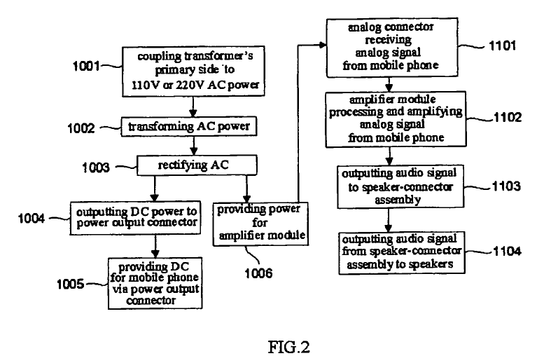

Referring to FIG. 2, the process flowchart of the method for playing MP3 files stored in a mobile phone according one embodiment of the present invention is shown. The method for playing MP3 files stored in a mobile phone comprises the following steps: coupling the primary side of transformer 510 to an alternating-current power source of 110V or 220V (1001); transforming the alternating-current power source (1002); rectifying the alternating current (1003); outputting a direct-current power to the power output connector 113 (1004); providing the direct-current power for a mobile phone 10 via the power output connector 113 (1005); providing a power for the amplifier module 200 (1006); the analog signal connector 111 receiving an analog signal from the mobile phone 10 (1101); the amplifier module 200 processing and amplifying the analog signal from the mobile phone 10 (1102); outputting an audio signal to the speaker-connector assembly 120 (1103); and outputting the audio signal from the speaker-connector assembly 120 to speakers 20 (1104).

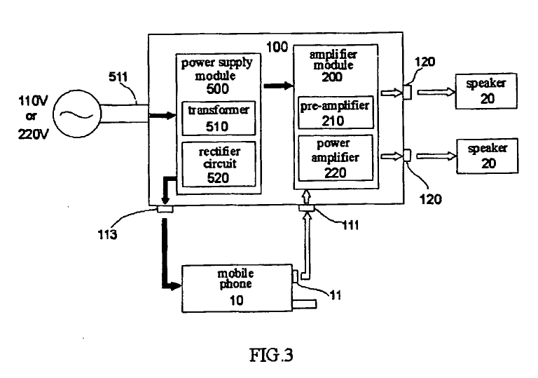

Referring to FIG. 3, the schematic diagram of the device for playing MP3 files stored in a mobile phone according to another embodiment of the present invention is shown. The amplifier module 200 of the device 100 for playing MP3 files stored in a mobile phone further comprises: a pre-amplifier 210 having the functions of adjusting the sound volume, selecting the signal source, and compensating the treble and bass, etc., via which a user can improve the sound quality according to his own desire; and a power amplifier 220, which can magnify the output volume.

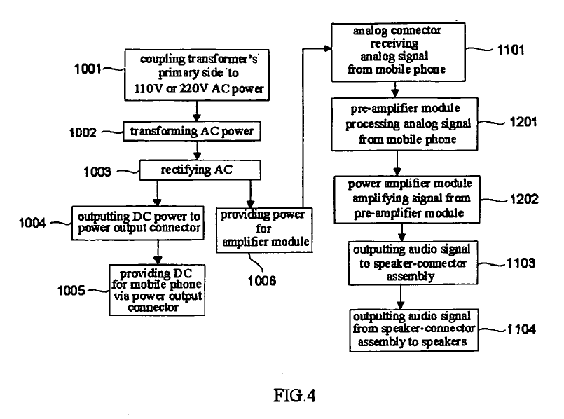

Referring to FIG. 4, the process flowchart of the method for playing MP3 files stored in a mobile phone according to another embodiment of the present invention is shown. The method for playing MP3 files stored in a mobile phone comprises the following steps: coupling the primary side of transformer to an alternating-current power source of 110V or 220V (1001); transforming the alternating-current power source (1002); rectifying the alternating current (1003); outputting a direct-current power to the power output connector (1004); providing the direct-current power for a mobile phone via the power output connector (1005); providing a power for the amplifier module (1006); the analog signal connector receiving an analog signal from the mobile phone (1101); the pre-amplifier module processing the analog signal from the mobile phone (1201); the power amplifier module amplifying the signal from the pre-amplifier module (1202); outputting an audio signal to the speaker-connector assembly (1103); and outputting the audio signal from the speaker-connector assembly to speakers (1104).

The signal output by the earphone socket of the mobile phone should be a two-channel signal. If the two-channel signal is directly amplified to output to the speakers without any processing, the sound sent out by the speakers is still of two channels; however, as there is a space configuration, the acoustic field is better, and the stereophonic effect thereof is superior to that of the sound directly sent out from the earphones.

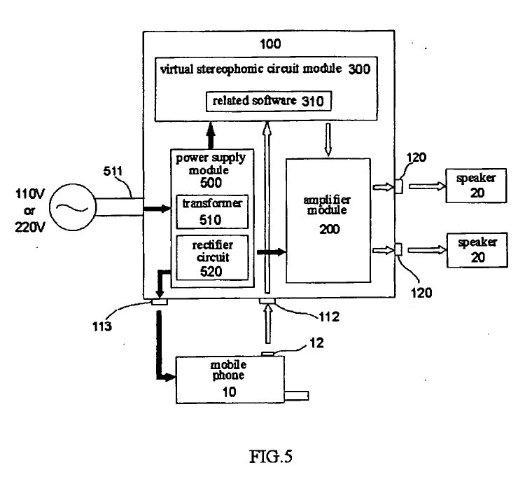

Referring to FIG. 5, the schematic diagram of the device for playing MP3 files stored in a mobile phone according to yet another embodiment of the present invention. The device 100 for playing MP3 files stored in a mobile phone further comprises a digital signal input/output (I/O) connector 112, which can be coupled to a digital signal I/O connector 12 of the mobile phone 10 and receive MP3 signals from the mobile phone 10. In the case that there are only two speakers or a pair of earphones, the device 100 for playing MP3 files stored in a mobile phone further comprises at least one virtual stereophonic circuit module 300 and a related software 310, such as the conventional Circle Surround II, TruSurround XT, SRS WOW, etc. The virtual stereophonic circuit module 300 can receive signals of a front-speaker of single-channel, two-channel, or multi-channel sound source from the digital signal I/O connector 112 and processes the front-speaker signals with a delay and then outputs them in order to simulate the delay of the echo reflected from the walls of the performance spaces which provides a superior virtual rear surround stereophonic effect for the case of having only two speakers or a pair of earphones. The aforementioned virtual stereophonic circuit module 300 and the related software 310 can further comprises the function of detecting and improving the mediant/bass and low-frequency portions of the sound source and simulating the effect of big-size speaker, such as the conventional TruBass technology, which can produce a deep and abundant sound quality and make users feel that the sound comes from a far distant speaker.

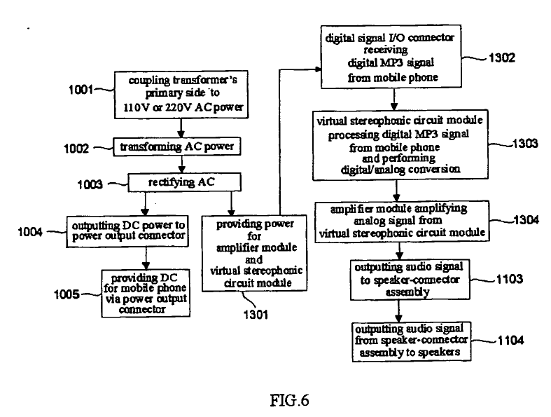

Referring to FIG. 6, The process flowchart of the method for playing MP3 files stored in a mobile phone according to yet another embodiment of the present invention is shown. The method for playing MP3 files stored in a mobile phone comprises the following steps: coupling the primary side of transformer to an alternating-current power source of 110V or 220V (1001); transforming the alternating-current power source (1002); rectifying the alternating current (1003); outputting a direct-current power to the power output connector (1004); providing the direct-current power for a mobile phone via the power output connector (1005); providing a power for the amplifier module 200 and the virtual stereophonic circuit module (1301); the digital signal I/O connector receiving a digital MP3 signal from the mobile phone (1302); the virtual stereophonic circuit module processing the digital MP3 signal from the mobile phone and performing a digital/analog conversion (1303); the amplifier module amplifying the analog signal from the virtual stereophonic circuit module (1304); outputting an audio signal to the speaker-connector assembly (1103); and outputting the audio signal from the speaker-connector assembly 120 to speakers (1104).

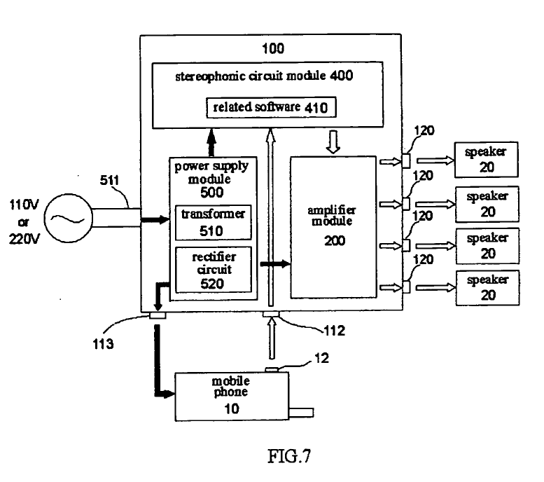

Referring to FIG. 7, the schematic diagram of the device for playing MP3 files stored in a mobile phone according to still another embodiment of the present invention is shown. The device 100 for playing MP3 files stored in a mobile phone further comprises at least one stereophonic circuit module 400 and a related software 410, which receives a digital MP3 signal from a digital signal I/O connector 112 and then performs a decoding and a digital/analog conversion. If the MP3 file contains four-channel or 5.1-channel information, for example, the MP3 file contains the encoding functions of Joint Stereo, Intensity Stereo (IS), or Mid/Side (M/S) Stereo, and/or the sound source comes from the Dolby Surround AC-3 technology, the stereophonic circuit module 400 can receive and decode the multi-channel digital MP3 signal from the digital signal I/O connector 12 of a mobile phone 10 and perform a digital/analog conversion. The analog signal output by the stereophonic circuit module 400 will be amplified and improved by the aforementioned at least one amplifier module 200 and then output to the speaker-connector assembly 120. The number of speaker connectors depends on the number of the channels output by the stereophonic circuit module 400; for example, if there are four channels, the signals of those four channels will be separately output to four speakers, and if there are 5.1 channels, the signals of those 5.1 channels will be separately output to six speakers, which will creates a depth of acoustic field, i.e. the sensation of in-situ music performance, better than that created by only two channels from two speakers. The aforementioned four channels include a left channel, a central channel, a right channel, and a band-limited low-frequency rear surround channel. The aforementioned 5.1 channels include a left channel, a central channel, a right channel, a left surround channel, a right surround channel, and a band-limited low-frequency rear surround channel.

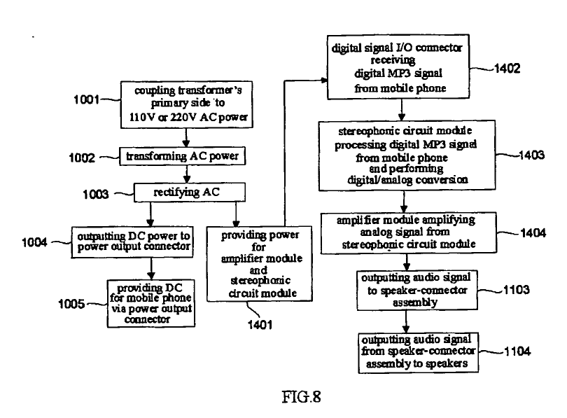

Referring to FIG. 8, the process flowchart of the method for playing MP3 files stored in a mobile phone according to still another embodiment of the present invention is shown. The method for playing MP3 files stored in a mobile phone comprises the following steps: coupling the primary side of transformer to an alternating-current power source of 110V or 220V (1001); transforming the alternating-current power source (1002); rectifying the alternating current (1003); outputting a direct-current power to the power output connector 113 (1004); providing the direct-current power for a mobile phone via the power output connector (1005); providing a power for the amplifier module and the stereophonic circuit module (1401); the digital signal I/O connector receiving a digital MP3 signal from the mobile phone 10 (1402); the stereophonic circuit module processing the digital MP3 signal from the mobile phone 10 and performing a digital/analog conversion (1403); the amplifier module amplifying the analog signal from the stereophonic circuit module (1404); outputting an audio signal to the speaker-connector assembly (1103); and outputting the audio signal from the speaker-connector assembly 120 to speakers (1104).

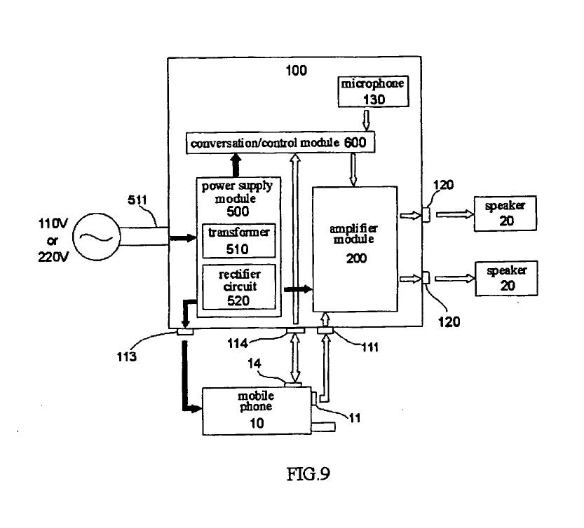

Referring to FIG. 9, the schematic diagram of the device for playing MP3 files stored in a mobile phone according to further another embodiment of the present invention is shown. As a phone conversation will be interfered during music playing, the device 100 for playing MP3 files stored in a mobile phone further comprises: a conversation/control module 600, which will automatically interrupt music playing once the mobile phone receives a signal of incoming call; and a conversation/control connector 114, via which the conversation/control signal can be transmitted between the mobile phone 10 and the device 100 for playing MP3 files stored in a mobile phone of the present invention. Once the mobile phone 10 receives a signal of incoming call, the signal of incoming call will be transmitted to the conversation/control module 600 via a control-signal connector 14 of the mobile phone 10 and the conversation/control connector 114, and the conversation/control module 600 will transmit a MP3-interrupting signal to the mobile phone 10 via the conversation/control connector 114 and the control-signal connector 14. As a user does not necessarily enjoy MP3 music with earphones, the user's hand might not reach the mobile phone 10 when there is an incoming call. Therefore, the device 100 for playing MP3 files stored in a mobile phone of the present invention can further comprises a microphone 130, and the aforementioned conversation/control module 600 can further comprises a voice-initiation function, which can initiate call receiving via a voice instruction, wherein after MP3 music playing has been interrupted and the microphone 130 has received a voice instruction of receiving call from the user, the conversation/control module 600 will transmit a call-receiving instruction through the conversation/control connector 114 to the control-signal connector 14 to order the mobile phone to receive the call. Despite the mobile phone has received the call via the voice instruction, the aforementioned voice-initiation function does not bring a real convenience for the user if he/she has to move for picking up the mobile phone 10 to near his/her ear for answering. Therefore, the device 100 of the present invention further comprises a circuit interconnecting the amplifier module 200 and the conversation/control module 600. The aforementioned conversation/control module 600 further comprises the following functions: the voice of the other party can be amplified by the amplifier module 200 and played by the speakers 20 during the conversation; the user's voice can be sent out via the conversation/control module 600 from the microphone 130 through the conversation/control connector 114 to the control-signal connector 14 and then to the mobile phone 10; and when the communication is over, the MP3 playing function will be automatically resumed.

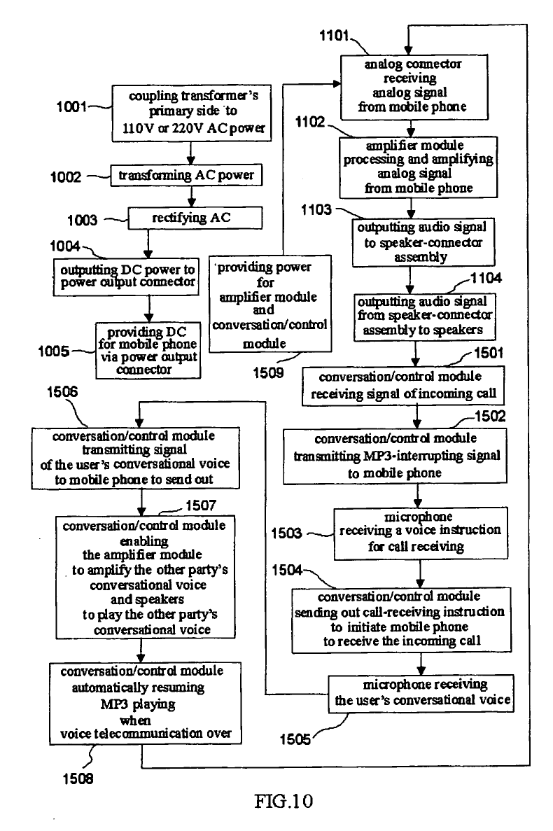

Referring to FIG. 10, the process flowchart of the method for playing MP3 files stored in a mobile phone according to further another embodiment of the present invention is shown. The method for playing MP3 files stored in a mobile phone comprises the following steps: coupling the primary side of transformer to an alternating-current power source of 110V or 220V (1001); transforming the alternating-current power source (1002); rectifying the alternating current (1003); outputting a direct-current power to the power output connector (1004); providing the direct-current power for a mobile phone via the power output connector (1005); providing a power for the amplifier module and the conversation/control module (1509); the analog signal connector receiving an analog signal from the mobile phone (1101); the amplifier module processing and amplifying the analog signal from the mobile phone (1102); outputting an audio signal to the speaker-connector assembly (1103); and outputting the audio signal from the speaker-connector assembly to speakers (1104); the conversation/control module receiving a signal of incoming call (1501); the conversation/control module transmitting an MP3-interrupting signal to the mobile phone (1502); the microphone receiving a voice instruction for call answering (1503); the conversation/control module sending out a call-receiving instruction to initiate the mobile phone to receive the incoming call (1504); the microphone receiving the user's conversational voice (1505); the conversation/control module transmitting the signal of the user's conversational voice to the mobile phone to send out (1506); the conversation/control module enabling the amplifier module to amplify the other party's conversational voice and the speakers to play the other party's conversational voice (1507); and the conversation/control module automatically resuming MP3 playing when the communication is over (1508).

According to yet further another embodiment of the present invention, the aforementioned conversation/control connector 114 and the aforementioned power output connector 113 can be integrated into a power/conversation/control connector. According to still further another embodiment of the present invention, the aforementioned conversation/control connector 114, the aforementioned power output connector 113 and the aforementioned digital signal I/O connector 112 can be integrated into a power/digital I/O/conversation/control connector.

According to still further another embodiment of the present invention, the device for playing MP3 files stored in a mobile phone further comprises a wireless earphone and an audio connector. Since the aforementioned virtual stereophonic circuit module and related software in the device of the present invention can provide a superior virtual rear surround stereophonic effect for the case of having only two speakers or a pair of earphones, the user can utilize the wireless earphones to enjoy the stereophonic music more easily without the rein of earphone cable.

According to still further another embodiment of the present invention, the device 100 for playing MP3 files stored in a mobile phone further comprises a casing, wherein the casing encases the aforementioned mobile phone-accommodating mechanism, the aforementioned power output connector, the aforementioned speaker-connector assembly, the aforementioned amplifier module, and the aforementioned power supply module.

According to still further another embodiment of the present invention, the device 100 for playing MP3 files stored in a mobile phone further comprise a casing, which encases the mobile phone-accommodating mechanism, all the elements, and all the modules of the present invention.

According to still further another embodiment of the present invention, the device 100 for playing MP3 files stored in a mobile phone further comprises two casings, wherein one casing encases the elements and modules relating to power and conversational control, such as the aforementioned mobile phone-accommodating mechanism, the aforementioned power supply module 500, the aforementioned power output connector 113, the aforementioned conversation/control module 600, the aforementioned conversation/control connector 114, and the aforementioned microphone 130, or the aforementioned power/ conversation/control connector; the other casing encases the elements, modules and software relating to audio function, such as at least module 200 mentioned above, the analog signal connector 111 or the digital signal I/O connector mentioned above, at least one virtual stereophonic circuit module 300 and related software 310 or at least one stereophonic circuit module 400 and related software 410 mentioned above. Further, there are cables of power, control, and signal interconnecting both casings.

It is to be noted that any modification, variation and design for achieving the objectives of the present invention according to the technical thoughts of the present invention should not depart from the spirit of the present invention and should be included within the scope of the present invention.

What is claimed is:

1. A device for playing MPEG Layer-3 (MP3) files stored in a mobile phone, comprising:
a mobile phone;
a power output connector connected to said mobile phone;
a signal connector, receiving audio signals of MP3 from said mobile phone;
at least one speaker connector assembly, outputting said MP3 audio signals to at least a speaker;
an amplifier module, connecting to said signal connector, processing audio signals of MP3 from said mobile phone, and outputting the processed signals to said speaker connector assembly; and
a power supply module, connecting to an external power, and providing power for said amplifier module and said power output connector.

2. A method for playing MP3 files stored in a mobile phone, comprising the following steps:
providing power for a power supply module to perform transformation and rectification;
providing power for a power output connector;
providing power for an amplifier module;
receiving audio signals of MP3 from said mobile phone by a signal connector;
processing and amplifying said audio signal of MP3 from said mobile phone by said amplifier module; and
outputting the processed and amplified signals from a speaker connector assembly to at least one speaker.

3. The device as claimed in claim 1, further comprising a casing, wherein said casing encases said power output connector, said signal connector, said speaker connector assembly, said amplifier module, and said power supply module.

4. The device as claimed in claim 1, further comprising a casing, wherein said casing encases said signal connector, said speaker connector assembly, and said amplifier module, wherein said amplifier module connects to said power supply module via a power cable.

5. The device as claimed in claim 1, further comprising a microphone and a conversation/control module.

6. The method as claimed in claim 2, further comprising the following steps:
providing power for said amplifier module and a conversation/control module;
receiving a signal of incoming call by said conversation/control module and sending an interrupt signal for interrupting MP3 playing to said mobile phone;
receiving the user's voice instruction for receiving an incoming call by microphone, said conversation/control module's sending an incoming call-receiving signal to initiate said mobile phone to receive said incoming call;
sending out the signal of said user's conversational voice from said mobile phone by said conversation/control module once said microphone receiving the user's conversational voice;
enabling the signal of the other party's conversational voice to be amplified by said amplifier module for said speakers' playing by said conversation/control module's; and
resuming the MP3 playing automatically by said conversation/control module's once the conversation is over.

7. The device as claimed in claim 1, further comprising a wireless transmitter module, which can wirelessly transmits signals output by said amplifier module to an earphone with a device of receiving wireless signal.

8. The device as claimed in claim 1, wherein said power output connector has the function of transferring a conversation/control signal.
